(19) United States
(12) Patent Application Publication
(10) Pub. No.: US 2008/0115122 A1
(43) Pub. Date: May 15, 2008

(54) UPDATING FIXTURE FOR BIOS IN COMPUTER SYSTEM

(75) Inventor: Hsien-Shan Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/938,767

(22) Filed: Nov. 12, 2007

(30) Foreign Application Priority Data
Nov. 13, 2006 (TW) 95141891

(51) Int. Cl. G06F 9/44

(52) U.S. Cl. 717/168

(57) ABSTRACT

An updating tool for a basic input output system (BIOS), which applies to firmware updating in a computer, is provided. The updating tool includes a first socket, a second socket, and an interface board. The first socket has a plurality of first pins and at least a first predetermined pin and is used to receive a first chip. The second socket has a plurality of second pins and at least a second predetermined pin and is used to receive a second chip. The interface board has a plurality of connection paths for connecting each of the first pins with the corresponding second pin, respectively, wherein the interface board further has a connection path for electrically connecting the second predetermined pin with one of the second pins.

### CROSS-REFERENCE TO RELATED APPLICATION

This application claims the priority benefit of Taiwan application serial no. 95141891, filed on Nov. 13, 2006. The entirety of the above-mentioned patent application is hereby incorporated by reference herein and made a part of this specification.

### BACKGROUND OF THE INVENTION

1. Field of the Invention

The invention relates to a tool and, more particularly, to a updating tool for a basic input output system in a device such as a computer.

2. Description of the Related Art

Recently, because of the rapid development of computers, there is a need for corresponding peripheral hardware to provide related support. A motherboard is especially important. The motherboard is mainly used to provide a platform for data exchange and transferring between a center process unit (CPU) and peripheral interfaces. To keep a computer stable when the computer is operating, a basic input output system (BIOS) of the motherboard should be periodically updated. The BIOS is mainly used to provide the CPU with instructions and data needed in a starting program. The motherboard usually stores the BIOS in different kinds of nonvolatile memory chips. The nonvolatile memory can ensure that data stored therein does not disappear when power supply is stopped. The available common memories include a read only memory, an electrically programmable read only memory, an electrically erasable programmable nonvolatile memory, or a flash memory.

In the past, computer manufacturers provided sockets on the motherboard to receive memories storing the BIOS therein. Recently, in consideration of manufacture costs of the motherboard, the memories storing the BIOS are directly soldered onto the motherboard. Once the BIOS is defective, the motherboard has to be delivered back to the original manufactory, or the memories have to be replaced via a solder dislodging operation.

To solve the above problem, US Patent Application No. 2005/0262398A1 discloses a flexible-cord-type updating tool for updating the BIOS. FIG. 1 is an architecture diagram showing a conventional flexible-cord-type updating tool. The flexible-cord-type updating tool 10 includes a top socket 50, a printed circuit board 52, a bottom socket 51, a first flexible cord 101, a second flexible cord 102, a third flexible cord 103, and a button switch 100. The top socket 50 and the bottom socket 51 are provided on opposite sides of the printed circuit board 52, respectively. The top socket 50 is used to receive a first memory 110, and the bottom socket 51 is used to receive a second memory 120 provided in a motherboard (not shown).

The button switch 100 in the flexible-cord-type updating tool 10 is used to control the first memory 110 and the second memory 120 to switch to a disabling or enabling state. Before a starting program is executed, the first memory 110 and the second memory 120 are inserted into the flexible-cord-type updating tool 10, and the button switch 100 is set to enable the first memory 110 and disable the second memory 120. After the staring program is completed, the button switch 100 is set to disable the first memory 110 and enable the second memory 120. Then related files to be burnt are loaded in the computer system. After the above steps are finished, the files are burnt to the second memory 120.

Although the above updating tool does not require detaching the memories when updating the BIOS, the button switch 100 has to be set manually to switch the first memory 110 and the second memory 120. Further, the updating tool 10 needs an external connection with the flexible cords (the first flexible cord 101, the second flexible cord 102, and the third flexible cord 103) and the button switch 100, and the tool may easily fall because of pulling and dragging in an installing or use state thus to increase risks in updating the BIOS. If the button switch 100 is pressed by mistake in updating the BIOS, data stored in the second memory 120 may be damaged.

### BRIEF SUMMARY OF THE INVENTION

An objective of the invention is to provide an updating tool for a basic input output system (BIOS) to conveniently update a chip storing the BIOS in a computer.

Another objective of the invention is to provide an operating method for an updating tool for a BIOS to fast update a chip storing the BIOS in a computer.

To achieve the above or other objectives, the invention provides an updating tool for a BIOS which applies to firmware updating in a computer. The updating tool includes a first socket, a second socket, and an interface board. The first socket has a plurality of first pins and at least a first predetermined pin and is used to receive a first chip. The second socket has a plurality of second pins and at least a second predetermined pin and is used to receive a second chip. The interface board has a plurality of connection paths for connecting each of the first pins with the corresponding second pin, respectively, wherein the interface board further has a connection path for electrically connecting the second predetermined pin with one of the second pins.

To achieve the above or other objectives, the invention provides an operating method for an updating tool for a BIOS, wherein the method includes the following steps. A first chip is provided in a first socket. A second socket is sleeved in a second chip on a motherboard of a computer system. The computer system reads a first BIOS from the first chip via the updating tool. The updating tool is removed from the motherboard of the computer system. The first BIOS is written from the computer system into the second chip.

An updating tool with dual-surface is provided in the invention, and therefore a first chip and a second chip can be received simultaneously. The updating tool disables the second chip by connecting a second predetermined pin of the second chip on a motherboard with one of second pins, and therefore the first chip can replace the second chip to provide a BIOS needed when the motherboard executes a starting program. The updating tool can be removed after the starting program is completed. After the updating tool is removed, a user can make the BIOS read from the first chip during a starting process written into the second chip. Therefore, the BIOS in the second chip can be fast updated without removing the second chip from the motherboard.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is an architecture diagram showing a conventional flexible-cord-type updating tool.

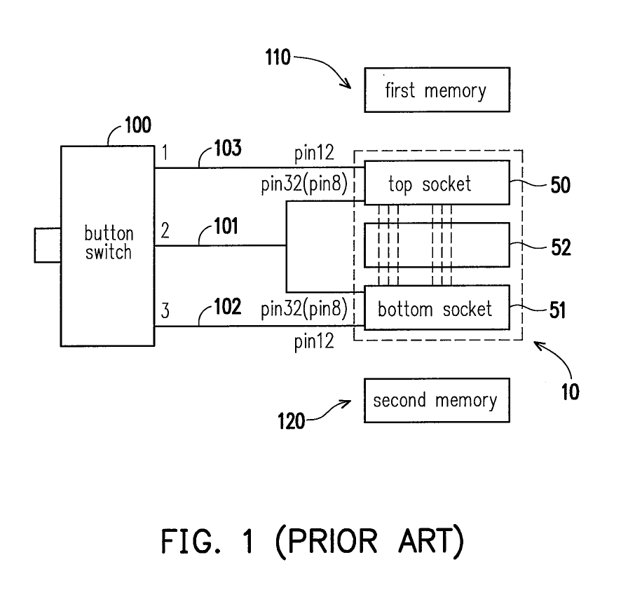

FIG. 2 is a three-dimensional schematic diagram showing an updating tool according to an embodiment of the invention.

FIG. 3 is an exploded diagram showing an updating tool according to an embodiment of the invention.

FIG. 4 is an operating method for updating a basic input output system (BIOS) by the updating tool shown in FIG. 3.

### DETAILED DESCRIPTION OF THE EMBODIMENTS

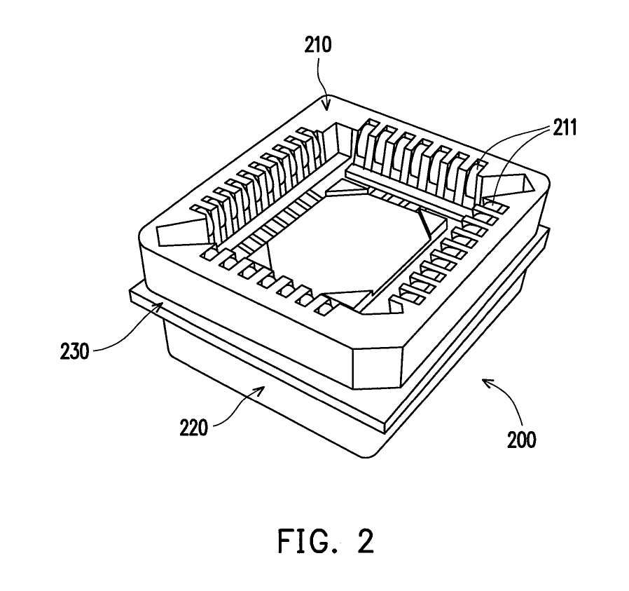

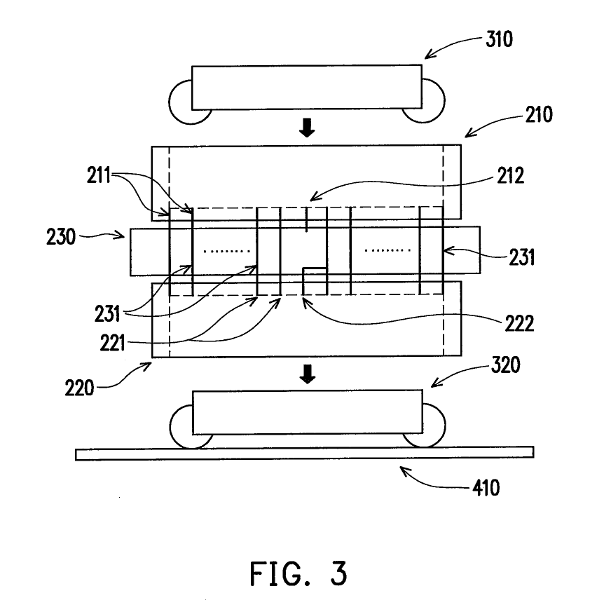

To conveniently update a basic input output system (BIOS) without removing a BIOS memory from a motherboard, the invention provides an updating tool. FIG. 2 is a three-dimensional schematic diagram showing an updating tool according to an embodiment of the invention. FIG. 3 is an exploded diagram showing an updating tool according to an embodiment of the invention. Please refer to FIG. 2 and FIG. 3 together. The updating tool 200 is a dual-surface socket. The updating tool 200 includes a first socket 210, a second socket 220, and an interface board 230. The first socket 210 has a plurality of first pins 211 and at least a first predetermined pin 212. A first chip 310 can be received in the first socket 210, and thus each pin of the first chip 310 is electrically connected with the corresponding pin of the first socket 210, respectively. The second socket 220 has a plurality of second pins 221 and at least a second predetermined pin 222. The second socket 220 can shield a second chip 320 to electrically connect each pin of the second chip 320 with the corresponding pin of the second socket 220. In this embodiment, the second chip 320 is fixedly provided on a motherboard 410 of a computer system.

To conveniently explain the invention, both the first chip 310 and the second chip 320 are, for example, SST49LF004B chips packaged by plastic leaded chip carrier (PLCC). However, the invention is not limited thereto. The first predetermined pin 212 and the second predetermined pin 222 are, for example, corresponding to enabling ends (pin numbers [symbol] 24 [symbol] , i.e. init pins) of the SST49LF004B chips. When the pin number [symbol] 24 [symbol] of the SST49LF004B chip is grounded, the SST49LF004B chip is disabled. If the pin number [symbol] 24 [symbol] of the SST49LF004B chip is coupled to a high logic level (or floatingly connected), the SST49LF004B chip is enabled.

The interface board 230 has a plurality of connection paths 231 for electrically connecting the first pins 211 of the first socket 210 with the second pins 221 of the second socket 220. For example, pin number [symbol] 1 [symbol] of the first pins 211 is electrically connected with pin number [symbol] 1 [symbol] of the second pins 221; pin number [symbol] 2 [symbol] of the first pins 211 is electrically connected with pin number [symbol] 2 [symbol] of the second pins 221; the corresponding order of the other pins can be deduced by analogy. Specially, in this embodiment, the predetermined pin 212 of the first socket 210 (such as pin number [symbol] 24 [symbol] and the second predetermined pin 222 of the second socket 220 (such as pin number [symbol] 24 [symbol] ) are not connected with each other. Here, the first predetermined pin 212 of the first socket 210 can remain floatingly connected, while the second predetermined pin 222 of the second socket 220 can be electrically connected to a grounding pin (such as pin number [symbol] 28 [symbol] ) of the second pins 221. The second predetermined pin 222 of the second socket 220 corresponds to the enabling end (the init pin) of the second chip 320, and the enabling end of the second chip 320 is electrically connected with one of the second pins 221 to disable the second chip 320 received in the second socket 220.

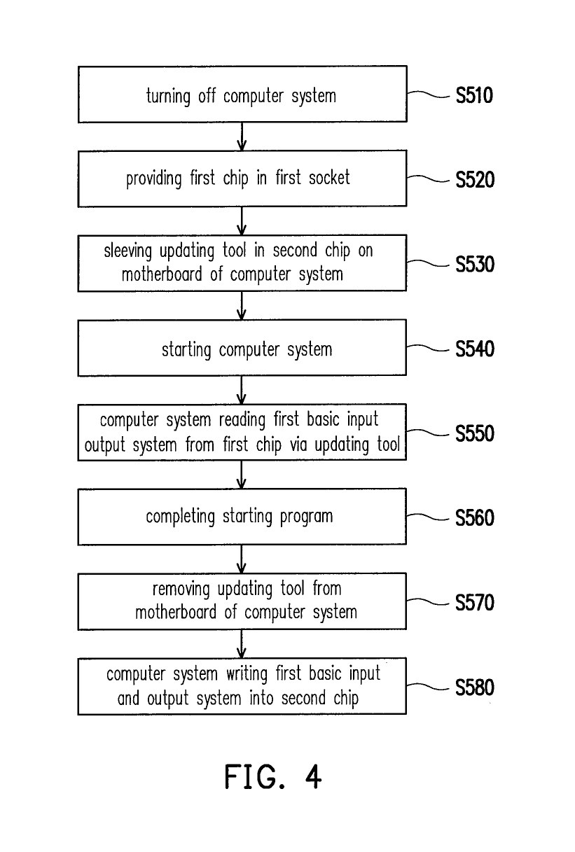

FIG. 4 is an operating method for updating a BIOS by the updating tool 200 of the embodiment. Please refer to FIG. 3 and FIG. 4 together. First, a step s510 is executed. That is, a computer system is turned off. A step s520 is executed to provide the first chip 310 in the first socket 210. Then the second socket 220 is sleeved in the second chip 320 on the motherboard 410 of the computer system (a step s530). At this moment, except the pin numbers [symbol] 24 [symbol] of the first chip 310 and the second chip 320, all the other pins are correspondingly connected with each other, respectively. After the updating tool 200 is sleeved in the second chip 320, a step s540 is executed to start the computer system. Most of the pins of the first chip 310 and the second chip 320 are connected in parallel to each other, and therefore the first chip 310 can be electrically connected with the motherboard 410 via the updating tool 200. As for the second chip 320, the init pin (the pin number [symbol] 24 [symbol] ) of the second chip 320 is electrically connected to a grounding pin of the second chip 320 via the second predetermined pin 222 of the second socket 220, the interface board 230, and the grounding pin of the second pins 221 (such as the pin number [symbol] 28 [symbol] ) in the updating tool 200 to disable the second chip 320. Contrarily, since the enabling end (the pin number [symbol] 24 [symbol] , i.e. the init pin) of the first chip 310 remains floatingly connected, the first chip 310 is in an enabling state. Therefore, in the starting process, the computer system can read the BIOS from the first chip 310 via the updating tool 200 (a step s550). Therefore, the problems encountered by the manual operations can be reduced without manually switching the enabling state of the chips of the updating tool 200.

In the above embodiment, the first predetermined pin 212 of the first socket 210 can remain floatingly connected. The first predetermined pin 212 of the first socket 210 can also be electrically connected to a power pin (such as a pin number [symbol] 25 [symbol] ) of the first pin 211 to enable the first chip 310.

In this embodiment, after the computer system completes the starting program (a step s560), the updating tool 200 can be removed from the motherboard 410 of the computer system (a step s570) to enable the second chip 320. After the updating tool 200 is removed, a step s580 is executed to write the BIOS previously read from the first chip 310 into the second chip 320.

As described above, the updating tool according to the embodiments of the invention can update the BIOS without detaching the memory chips storing the BIOS. Compared with the conventional flexible-cord-type updating tool, first, the invention does not need an external connection with flexible cords, and therefore detachment of the tool because of pulling and dragging of the flexible cords in use can be avoided; second, the invention does not need to manually switch a button switch.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An updating tool for a basic input output system comprising:
a first socket having a plurality of first pins and at least a first predetermined pin, wherein the first socket is used to receive a first chip;
a second socket having a plurality of second pins and at least a second predetermined pin, wherein the second socket is used to receive a second chip; and
an interface board having a plurality of connection paths for connecting each of the first pins with the corresponding second pin, respectively, wherein the interface board further has a connection path for electrically connecting the second predetermined pin with one of the second pins.

2. The updating tool for a basic input output system according to claim 1, wherein the second chip is fixedly provided on a motherboard of a computer system.

3. The updating tool for a basic input output system according to claim 1, wherein the second predetermined pin of the second socket corresponds to an enabling end of the second chip, and the enabling end of the second chip is electrically connected with one of the second pins to disable the second chip received in the second socket.

4. The updating tool for a basic input output system according to claim 1, wherein the second pin of the second socket electrically connected with the second predetermined pin corresponds to a grounding end of the second chip.

5. The updating tool for a basic input output system according to claim 1, wherein the first predetermined pin of the first socket is floatingly connected to enable the first chip received in the first socket.

6. An operating method for the updating tool of claim 1 comprising:
providing the first chip in the first socket;
sleeving the second socket in the second chip on a motherboard of a computer system;
the computer system reading a first basic input output system from the first chip via the updating tool;
removing the updating tool from the motherboard of the computer system;
writing the first basic input output system from the computer system into the second chip.

7. The operating method for the updating tool according to claim 6, further comprising:
sleeving the second socket in the second chip on the motherboard of the computer system when the computer system is turned off; and
starting the computer system;
wherein a second predetermined pin of the second socket is electrically connected with one of the second pins to disable the second chip received in the second socket, and the first chip received in the first socket is enabled.

8. The operating method for the updating tool according to claim 7, further comprising:
removing the updating tool from the motherboard of the computer system to enable the second chip after the computer system completes a starting program.

9. The operating method for the updating tool according to claim 6, wherein the second chip is fixedly provided on the motherboard of the computer system.

10. The operating method for the updating tool according to claim 6, wherein the second predetermined pin of the second socket corresponds to an enabling end of the second chip, and the enabling end of the second chip is electrically connected with one of the second pins to disable the second chip received in the second socket.

11. The operating method for the updating tool according to claim 6, wherein the second pin of the second socket electrically connected with the second predetermined pin corresponds to a grounding end of the second chip.

12. The operating method for the updating tool according to claim 6, wherein the first predetermined pin of the first socket is floatingly connected to enable the first chip received in the first socket.
